(19) United States
(12) Patent Application Publication
(10) Pub. No.: US 2013/0154409 A1
(43) Pub. Date: Jun. 20, 2013

(54) DISK DRIVE DEVICE

(71) Applicant: ALPHANA TECHNOLOGY CO., LTD., Fujieda-City (JP)

(72) Inventors: Osamu YAMADA, Shizuoka City (JP); Shinji TANAKA, Yaizu City (JP)

(73) Assignee: ALPHANA TECHNOLOGY CO., LTD., Fujieda-City (JP)

(21) Appl. No.: 13/674,273

(22) Filed: Nov. 12, 2012

(30) Foreign Application Priority Data
Dec. 19, 2011 (JP) 2011-276688

(51) Int. Cl. G11B 33/14; H02K 3/50; G06F 1/16

(52) U.S. Cl. CPC G11B 33/1446; G06F 1/16; H02K 3/50
USPC 310/71; 361/679.33

(57) ABSTRACT

A disk drive device includes a base with a base opening, a rotating body provided in the base at the first face side and to which a recording disk is to be mounted, a wiring member including a first film, a second film, and a wiring conductor, and provided on the second face of the base to cover the base opening, a lead wire passing through the base opening and fixed to a wire connection portion of the wiring conductor, a thickness decreasing portion decreasing a thickness in accordance with an edge of the wiring conductor, and located outwardly of the base opening in a planar direction, and a slot which is an area having no conductor and having an entire circumference surrounded by the wiring conductor between the first and the second films in the planar direction, and present between the wire connection portion and the thickness decreasing portion.

### BACKGROUND OF THE INVENTION

1. Field of the Invention

The present invention relates to a disk drive device which includes a wiring member attached to a base so as to cover a base opening and which rotates and drives a disk.

2. Description of the Related Art

Hard disk drives are known as media used for a memory device, etc., of a computer. Hard disk drives cause a brushless motor to rotate a magnetic recording disk formed with recording tracks at a fast speed. In order to read/write magnetic data in the recording tracks, a magnetic head is disposed above the surface of the magnetic recording disk with a slight clearance. For example, JP 2010-218612 A discloses a disk drive device that has a motor wire which is drawn to the lower face of a base through an opening provided in the base and which is coupled with a driving wiring.

An area in a hard disk drive where the magnetic recording disk is placed is normally filled with clean air having particles, etc., that are tiny particles like organic materials and nonorganic materials eliminated and is sealed and closed. When, for example, the base opening provided in the base for drawing a wire like a motor lead wire causes a leak, external particles may enter in the space where the magnetic recording disk is placed through the leaking base opening. When the particles are present between the magnetic recording disk and the magnetic head, read/write operation of data is disrupted, and it becomes a case in the worst case in which the hard disk drive becomes defective.

An example wiring member of the disk drive device available is a flexible printed circuit firmly attached to the lower face of the base. A wire is drawn from the upper face side of the base to the lower face side thereof through the base opening, and is coupled with the flexible printed circuit. It is typical that the flexible printed circuit is formed of a wiring conductor laminated between two resin films, and the surface of such flexible printed circuit may have a concavity and a convexity. When such a flexible printed circuit is attached to the lower face of the base, a gap is formed between the base and the flexible printed circuit in accordance with the concavity and convexity of the surface of the flexible printed circuit. Such a gap may form a passage in a planar direction that reaches the edge of the flexible printed circuit along the concavity and convexity. When the passage overlaps the base opening and is in communication therewith, a leak passage reaching the edge of the flexible printed circuit is formed in the base opening, resulting in a poor air-tightness of the base opening. The flexible printed circuit may be firmly pushed against the base so as to make the gap by the concavity and convexity collapsed, but the leak through the concavity and convexity cannot be eliminated completely, and the base and the flexible printed circuit may be deformed.

The same is true of disk drive devices of other kinds.

The present invention has been made in view of the above-explained disadvantage, and it is an object of the present invention to provide a disk drive device that suppresses a leakage from a base opening provided in a base for drawing a wire like a motor lead wire.

### SUMMARY OF THE INVENTION

To achieve the above object, a first aspect of the present invention provides a disk drive device that includes: a base formed with a base opening that passes all a way through a first face and a second face opposite to the first face; a rotating body which is provided in the base at the first face side and to which a recording disk is to be mounted; a wiring member which includes a first film, a second film, and a wiring conductor present between the first film and the second film, and which is provided on the second face of the base to cover the base opening; a lead wire which passes through the base opening and which is fixed to a wire connection portion of the wiring conductor; a thickness decreasing portion which is a part of the wiring member, decreases a thickness in accordance with an edge of the wiring conductor, and is located outwardly of the base opening in a planar direction; and a slot which is a part of the wiring member, is an area having no conductor and having an entire circumference surrounded by the wiring conductor between the first film and the second film in the planar direction, and is present between the wire connection portion and the thickness decreasing portion.

To achieve the above object, a second aspect of the present invention provides a disk drive device that includes: a base which comprises a first face and a second face opposite to the first face, and which is formed with a base opening passing all a way through the first face and a second face; a motor which comprises a coil and which is retained in the base at the first face side; and a wiring member which comprises a first film, a second film and a wiring conductor present between the first film and the second film and electrically coupled with the coil of the motor, and which is disposed on the second face in such a way that a portion of the wiring member corresponding to an area where the wring conductor is present between the first film and the second film surrounds an outer edge of the base opening.

To achieve the above object, a third aspect of the present invention provides a disk drive device that includes: a motor configured to rotate and drive a disk; a wire extending from the motor; a base which comprises a first face and a second face, retains the motor at the first face side, and is formed with a base opening that allows the wire to pass through from the first face side to the second face side; a wiring member that comprises a first film, a second film, and a wiring conductor disposed between the first film and the second film and electrically coupled with the wire, a portion of the wiring member corresponding to an area where no wiring conductor is present between the first film and the second film being disposed outwardly of the base opening in a planar direction; and a slot which is a pore provided in the wiring conductor and having an entire circumference surrounded by the wiring conductor, and which is provided around a portion where the wiring member is coupled with the wire.

Any combinations of the above-explained structures and replacements of the structures and expression of the present invention with a method, an apparatus, and a system are also effective as an aspect of the present invention.

According to the present invention, a leakage from the base opening which is provided in the base and which is for drawing a wire like a lead wire of a motor can be suppressed.

### BRIEF DESCRIPTION OF THE DRAWINGS

FIG. 1 is a perspective view illustrating a disk drive device according to an embodiment of the present invention;

FIG. 2 is a partial cross-sectional view of the disk drive device according to an embodiment of the present invention;

FIG. 3 is a partial enlarged cross-sectional view illustrating the disk drive device illustrated in FIG. 2;

FIG. 4 is a partial bottom view of the disk drive device illustrated in FIG. 2;

FIG. 5 is a plan view illustrating another example wiring member;

FIG. 6 is an exemplary diagram illustrating a cross section of the wiring member;

FIG. 7 is an exemplary diagram illustrating a cross section having the wiring member attached to the lower face of a base; and

FIG. 8 is an exemplary bottom diagram illustrating a passage in a planar direction with the wiring member being attached to the lower face of the base.

### DETAILED DESCRIPTION OF THE PREFERRED EMBODIMENTS

An explanation will be given of the present invention through preferred embodiments thereof with reference to the accompanying drawings. The same or equivalent structure and component illustrated in respective drawings will be denoted by the same reference numeral, and the duplicated explanation will be omitted accordingly. The dimension of each member in each drawing is enlarged or reduced as needed in order to facilitate understanding to the present invention. A part of each member not important to explain an embodiment of the present invention in each drawing will be illustrated in an omitted manner.

A disk drive device according to an embodiment of the present invention is suitably used as, in particular, a hard disk drive that has a recording disk which magnetically records data.

### Embodiments

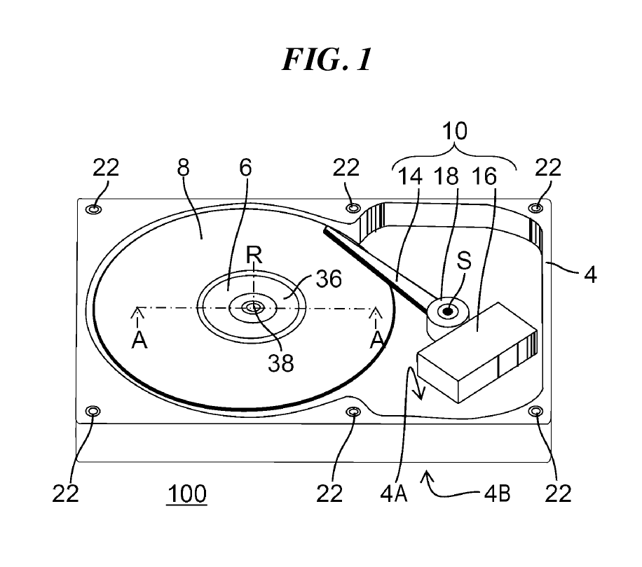

FIG. 1 is a perspective view illustrating a disk drive device 100. FIG. 1 illustrates a condition in which a top cover (unillustrated) is detached in order to make the internal structure of the disk drive device 100 visible. The disk drive device 100 includes a base 4, a rotating body 6, a recording disk 8, a data reader/writer 10, and a bearing unit 12.

In the following explanation, a side where the rotating body 6 is placed relative to the base 4 is defined as an upper side. A direction along a rotational axis R of the rotating body 6, a radial direction from the rotational axis R to the rotating body 6, and a direction along a plane orthogonal to the rotational axis R of the rotating body 6 are simply referred to as an axial direction or a thickness direction, a radial direction, and a planar direction, respectively.

The recording disk 8 is, for example, a 2.5-inch recording disk having a diameter of 65 mm and formed of glass. The diameter of a center hole is, for example, 20 mm, and the thickness of such a disk is, for example, 0.65 mm.

The recording disk 8 is mounted on the rotating body 6, and rotates together with a rotation of the rotating body 6. The rotating body 6 is attached to the base 4 through the bearing unit 12 unillustrated in FIG. 1 in a freely rotatable manner.

The base 4 includes an upper face 4A that is a first face and a lower face 4B that is a second face opposite to the upper face 4A. The base 4 also includes a bottom plate that defines the bottom of the disk drive device 100 and an outer circumferential wall formed along the outer circumference of the bottom plate. The outer circumferential wall is provided so as to surround an area where the recording disk 8 is placed. The outer circumferential wall has screw holes provided in an upper face thereof. For example, the base 4 can be formed as follows. First of all, an aluminum alloy is formed in a desired shape by die-casting. Next, a coating like an epoxy resin is applied to the surface of the casted piece. Subsequently, some of the coatings are eliminated by cutting.

The data reader/writer 10 includes a recording/playing head (unillustrated), a swing arm 14, a voice coil motor 16, and a pivot assembly 18. The recoding/playing head is attached to the tip of the swing arm 14, records data in the recording disks 8, or reads the data therefrom. The pivot assembly 18 supports the swing arm 14 in a swingable manner to the base 4 around a head rotating shaft S. The voice coil motor 16 allows the swing arm 14 to swing around the head rotating shaft S to move the recording/playing head to a desired location over the top face of the magnetic recording disk 8. The voice coil motor 16 and the pivot assembly 18 are configured by a conventionally well-known technology of controlling the position of a head.

In this embodiment, one including all components like the recording disk 8 and the reader/writer 10 may be referred to as the disk drive device 100 or an HDD. Moreover, only the portion for rotating and driving the recording disk 8 may be referred to as the disk drive device 100 in some cases.

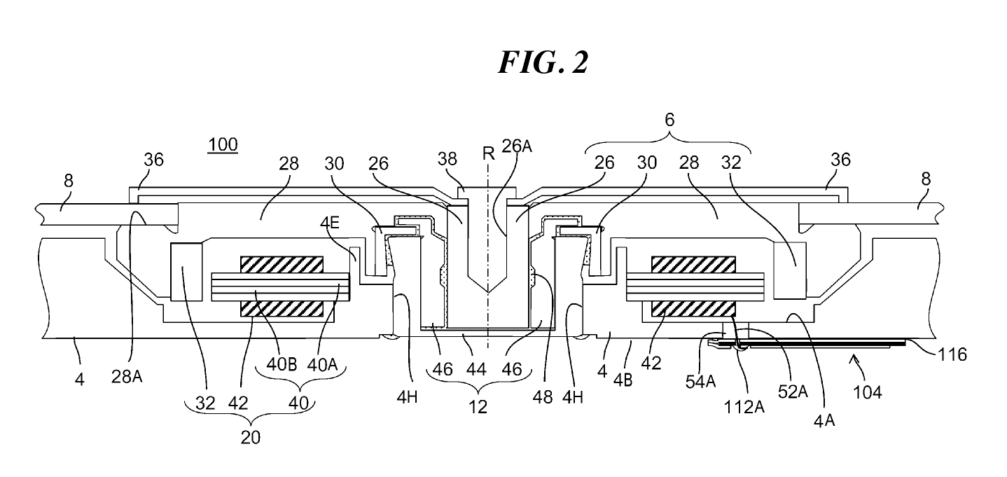

FIG. 2 is a cross-sectional view taken along a line A-A in FIG. 1. The disk drive device 100 further includes a core 40, coils 42, and a wiring member 104. An annular wall 4E in an annular shape around the rotational axis R of the rotating body 6 is provided on an upper face 4A of the base 4. The core 40 includes an annular part 40A and twelve protrusions 40B extending outwardly from the annular part 40A in the radial direction, and is fixed on the upper face 4A of the base 4. The core 40 is formed by, for example, stacking four pieces of thin magnetic steel sheet, and integrating those together by caulking. An insulating painting is applied to the surface of the core 40 by electrodeposition painting or powder coating. The annular part 40A is press-fitted to the outer circumference surface of the annular wall 4E, thereby fixing the core 40 to the base 4. A bond may be present between the annular part 40A and the annular wall 4E.

The base 4 is provided with a bearing hole 4H around the rotational axis R of the rotating body 6. The bearing unit 12 includes a housing 44 and a sleeve 46, and supports the rotating body 6 in a freely rotatable manner relative to the base 4. The housing 44 includes a cylinder part and a bottom part to be integrally formed in a cup shape with a bottom, and is fixed to the bearing hole 4H of the base 4 by, for example, bonding with the bottom of the cup being directed downwardly.

The housing 44 is formed of, for example, a copper alloy, and nickel plating is applied to an outer circumference surface of the housing 44. The sleeve 46 is a cylindrical member bonded and fixed to an inner side face of the housing 44. The sleeve 46 has a protrusion which is formed at an upper end of the sleeve 46 and which protrudes outwardly of the radial direction. The protrusion restricts the movement of the rotating body 6 in the axial direction, i.e., the direction of the rotational axis R together with a flange 30.

A shaft 26 is retained in the sleeve 46. A space between the shaft 26, a hub 28, and the flange 30, and, the bearing unit 12 is filled with a lubricant 48.

A pair of radial dynamic pressure grooves (unillustrated) in a herringbone shape apart from each other in the vertical direction are formed in the inner circumference surface of the sleeve 46. A first thrust dynamic pressure groove (unillustrated) in a herringbone shape is formed in the lower face of the flange 30 facing the upper face of the housing 44. A second thrust dynamic pressure groove (unillustrated) in a herringbone shape is formed in the upper face of the flange 30 facing the lower face of the protrusion of the sleeve 46. When the rotating body 6 rotates, those dynamic pressure grooves produce dynamic pressures to the lubricant 48 which supports the rotating body 6 in the radial direction and in the direction of the rotational axis R.

The rotating body 6 includes a shaft 26, the hub 28, the flange 30, and a cylindrical magnet 32. The recording disk 8 is mounted on a disk mount face 28A of the hub 28. A screw hole 26A is provided in the upper face of the shaft 26 in a coaxial manner with the rotational axis R. A clamper 36 is crimped to an upper face 28B of the hub 28 by a disk fixing screw 38 threaded in the screw hole 26A, and clamps the recording disk 8 to the disk mount face 28A of the hub 28.

The hub 28 is formed of an iron-steel material with a soft magnetism like SUS430F. The hub 28 is formed by, for example, pressing or cutting a piece of iron-steel sheet, and is formed in a predetermined shape like a substantially cup shape.

The shaft 26 is fixed to and fitted in a hub opening provided in the center of the hub 28 and coaxial with the rotational axis R of the rotating body 6 by both press-fitting and bonding. The flange 30 is in an annular shape, and has a cross section that is in a reversed L shape. The flange 30 is fixed to the inner circumference surface of a sagged part of the hub 28 by bonding.

The cylindrical magnet 32 is bonded and fixed to a cylindrical inner circumference surface corresponding to the inner cylindrical surface of the hub 28 in the substantially cup shape. The cylindrical magnet 32 is a rare-earth magnet formed of a material, such as neodymium, iron, or boron, and faces the twelve protrusions 40B of the core 40 in the radial direction. The cylindrical magnet 32 has drive magnetic poles that are 16 poles in the circumferential direction of the cylindrical magnet 32. Rust-proofing is applied to the surface of the cylindrical magnet 32 by, for example, electrodeposition painting or spray painting.

Each protrusion 40B of the core 40 is provided with the coil 42. The coil 42 is formed by, for example, winding a wire including a copper wire and an insulative layer like a urethane resin formed on the surface of the copper wire. The coil 42 is formed by winding such a wire around each protrusion 40B of the core 40. The winding of the wire starts from the bottom side of any given protrusion, and the wire is successively wound around a protrusion forming the same phase as that of the former protrusion in the case of, for example, three-phase driving from the upper side of that protrusion. The winding end of the wire is drawn to the bottom side of the protrusion.

The core 40, the coils 42, and the cylindrical magnet 32 construct a brushless motor 20. When a three-phase drive current of a substantially sinusoidal waveform flows through the coils 42, field magnetic fluxes are produced along respective protrusions. Torque is given to the cylindrical magnet 32 by a mutual action of the field magnetic fluxes and the driving magnetic poles, and thus the hub 30 rotates.

The disk drive device 100 of this embodiment includes the brushless motor 20 provided at the upper-face-4A side of the base 4. The brushless motor 20 rotates the rotating body 6. A lead wire 52A has one end coupled to the brushless motor 20. More specifically, the coils 42 of the brushless motor 20 employ a structure of three-phase Y-connection. The coils of each phase each have a start wire end and a termination wire end. Three start wire ends of respective phases are bundled and electrically connected together by, for example, soldering, and form a center point (unillustrated) of the Y-connection. The center point of the Y-connection is insulated and is retained in a predetermined space. The lead wire may be electrically connected to three termination wired ends of respective phases in a manner separable from those wire ends. In this embodiment, three termination wire ends of the coils of respective phases are elongated to form lead wires 52A, 52B, and 52C (52B and 52C are unillustrated) at respective leading ends. That is, the wire of the coil and the lead wire are formed integrally. It is preferable since a work for connecting those wires is unnecessary. The lead wires 52A, 52B, and 52C are drawn to the lower-face-4B side that is the second face of the base 4 through respective base openings 54A, 54B, and 54C (54B and 54C are unillustrated) provided in the base 4. Hereinafter, an explanation will be given of an example structure in which the lead wire 52A is drawn to the lower-face-4B side through the base opening 54A and is wired.

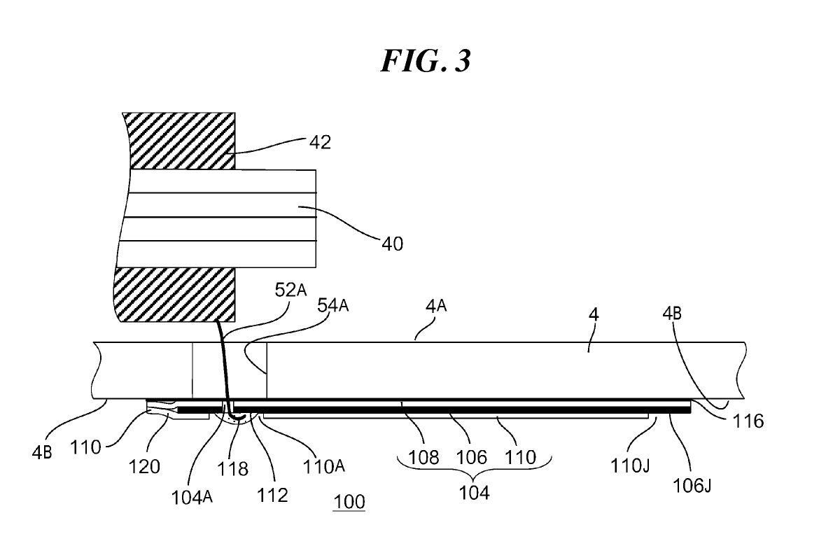

FIG. 3 is a partial enlarged cross-sectional view of the disk drive device 100 according to this embodiment.

A wiring member 104 which includes a strip base film 108, a strip cover film 110, and a strip wiring conductor 106 laminated between the base film 108 and the cover film 110 and serving as a drive wiring is firmly attached to the lower face 4B of the base 4. The wiring member 104 has a bond member provided between the base film 108 and the base 4, thereby being bonded to the lower face 4B. When a double-sided tape 116 is used as the bond member, it needs substantially no curing time, resulting in a good work efficiency. The base film 108 and the cover film 110 are each formed of, for example, a polyimide or polyester film with a thickness of, for example, 12 to 50 μm and are each formed in a predetermined shape through a conventionally well-known technique. The wiring conductor 106 is formed of, for example, a copper foil with a thickness of, for example, 12 to 50 μm and is formed in a predetermined shape through a conventionally well-known technique. The wiring member 104 is bonded to the lower face 4B of the base 4 so as to cover the outer circumference of the base opening 54A.

The wiring member 104 has a wire connection portion 112 at one end in the planar direction, and has another connection portion 106J at another end. A wire (unillustrated) leading to a drive circuit (unillustrated) is electrically connected to another connection portion 106J. Since the wiring conductor 106 is successive between the wire connection portion 112 and another connection portion 106J, the drive circuit can supply a drive current to the coils 42 through the wiring conductor 106. The wiring member 104 has openings 110A and 110J of the cover film 110 formed at respective corresponding locations to the wire connection portion 112 and another connection portion 106J. The wiring conductor 106 has a conductor exposed at respective areas corresponding to the openings 110A and 110J of the cover film 110. The wiring member 104 has a film opening 104A which is formed at a location at least partially overlapping the base opening 54A in the planar direction and which passes all the way through the wiring member 104. The lead wire 52A passes through the base opening 54A and the film opening 104A, reaches and extends to the lower face of the cover film 110. The tip of the lead wire 52A is bent substantially at a right angle toward another connection portion 106J. The tip of the lead wire 52A is fixed to the wire connection portion 112 by, for example, soldering with a solder 118, and is electrically connected to the wire connection portion 112.

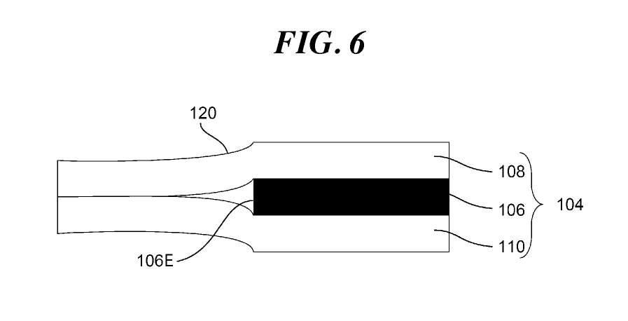

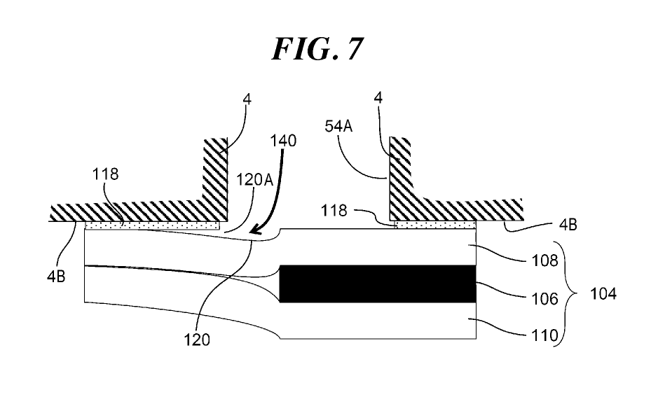

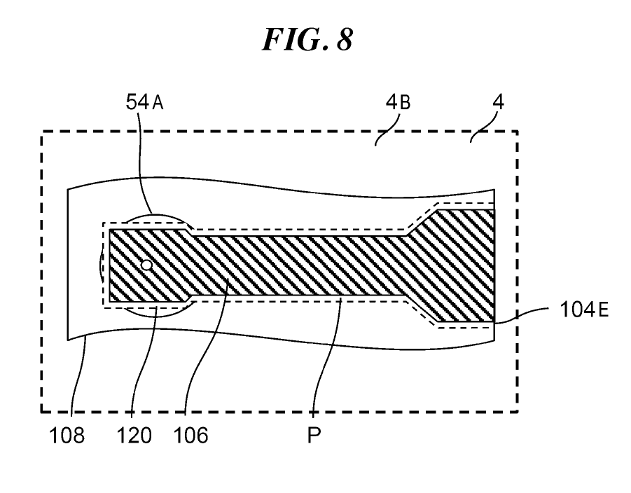

The inventors of the present invention studied the reason that causes a leakage from the base opening, and reached following finding. FIG. 6 is an exemplary diagram illustrating a cross section of the wiring member 104. FIG. 6 and following FIGS. 7 and 8 illustrate characteristic portions in an emphatic manner to facilitate understanding to the present invention. As illustrated in FIG. 6, the wiring member 104 has, between the base film 108 and the cover film 110, a present area where the wiring conductor 106 is present and an absent area where the wiring conductor 106 is not present. The thickness of the portion of the absent area apart from the present area is thinner than the present area by what corresponds to the thickness of the wiring conductor 106. The absent area forms a thickness decreasing portion 120 that is an area which is formed at the outward circumference of an external edge 106E of the wiring conductor 106 in the planar direction and which has a thickness decreasing gradually by what corresponds to the conductor. FIG. 7 is an exemplary diagram illustrating a cross section with the wiring member 104 being attached to the lower face 4B of the base 4. When the wiring member 104 is attached to the lower face 4B of the base 4, a space 120A is formed between the thickness decreasing portion 120 and the base 4. When the space 120A overlaps the base opening 54A in the planar direction, as indicated by an arrow 140, the base opening 54A is in communication with the space 120A. FIG. 8 is a bottom exemplary diagram illustrating a planar-direction passage P with the wiring member 104 being attached to the lower face 4B of the base 4. In order to facilitate understanding, FIG. 8 illustrates no cover film 110. Moreover, only the base opening 54A portion of the base 4 is illustrated. The space 120A forms a passage P (a space between the hatched portion and a dashed line) in the planar direction along the edge of the wiring conductor 106 (hatched portion). The passage P is continuously formed to an external edge 104E of the wiring member 104 along the edge of the wiring conductor 106. Hence, if the passage P is in communication with the base opening 54A at least partially, the base opening 54A forms a leak passage for particles. That is, the inventors of the present invention found that when the thickness decreasing portion 120 continuous to the external edge of the wiring member 104 overlaps the base opening 54A in the planar direction, it causes a deterioration of the air-tightness of the base opening 54A.

In this embodiment, the wiring member 104 has the base film 108 and the cover films 110 each formed to a thickness of, for example, 25 μm, and has the wiring conductor 106 formed to a thickness of, for example, 35 μm. As a result, the thickness of the wiring member 104 is 85 μm at the present area where the wiring conductor 106 is present, and is 50 μm at an area other than the thickness decreasing portion 120 of the absent area where the wiring conductor 106 is not present. That is, a gap of substantially 17 μm at one side is produced in the thickness decreasing portion 120 formed along the edge of the wiring conductor 106. When such a wiring member 104 is attached to the lower face 4B of the base 4, the passage P in the planar direction along the thickness decreasing portion 120 is inevitably formed.

In view of the above-explained finding, according to this embodiment, the thickness decreasing portion 120 is provided at a location outwardly of the base opening in the planar direction. That is, the external edge of the base opening 54A is surrounded by a portion of the wiring member 104 corresponding to the area where the wiring conductor 106 is present between the base film 108 and the cover film 110. Hence, it becomes possible to reduce a possibility that the base opening 54A becomes in communication with the passage P and thus the air-tightness becomes poor.

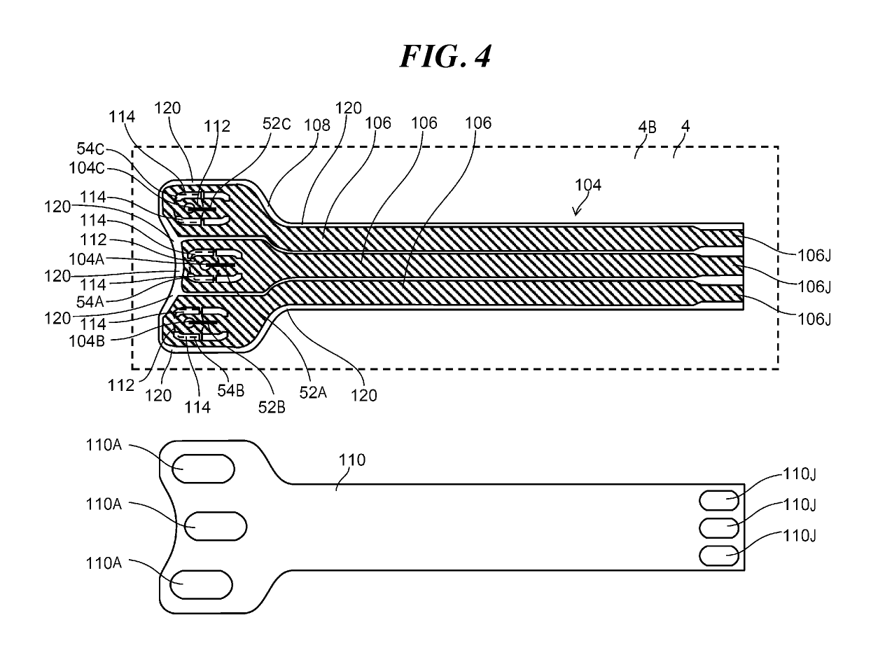

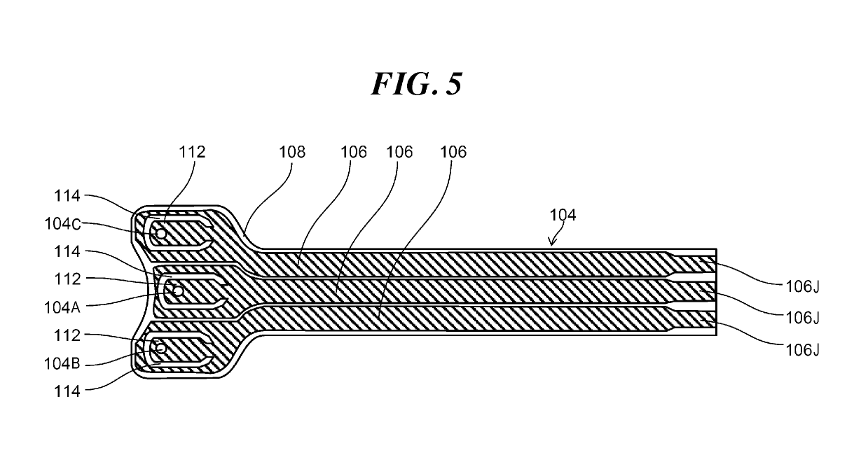

FIG. 4 is a partial bottom view of the disk drive device illustrated in FIG. 2 around the wiring member 104. FIG. 4 illustrates the wiring member 104 having the cover film 110 eliminated and the cover film 110 separated from the wiring member 104 in order to facilitate understanding, and also illustrates a condition with no solder 118. FIG. 5 is a plan view illustrating another example of the wiring member 104 in FIG. 4. FIG. 5 illustrates a condition in which the cover film 110 is eliminated in order to facilitate understanding. The outer contour line indicates the outer contour of the base film 108. The hatched area indicates the wiring conductor 106 that is an area where the conductor is present.

First of all, an explanation will be given with reference to FIG. 4. Since the wiring conductor 106 has a higher thermal conductivity than those of the base film 108 and the cover film 110, heat is transmitted along the wiring conductor 106. Hence, when the area of the wiring conductor 106 around the wire connection portion 112 is large, the thermal capacity of the wire connection portion 112 increases in accordance with that area. When the thermal capacity of the wire connection portion 112 increases, a time until a solder reaches a temperature at which the solder is melted when the solder is contacted with a soldering iron becomes long. As a result, a time necessary for soldering the lead wire 52A to the wire connection portion 112 becomes long, resulting in a poor work efficiency. A soldering iron having a heater with a large heat generation amount may be used in this case, but when such a soldering iron is used, the lead wire 52A and the wiring conductor 106 may be deteriorated due to the large heat of such a soldering iron. In order to address this disadvantage, according to this embodiment, a slot 114 which is an area where no conductor is present between the wire connection portion 112 and the thickness decreasing portion 120 in the planar direction and between the base film 108 and the cover film 110 is separately provided from the external area of the wiring member 104. Since the slot 114 has no conductor, the slot 114 can suppress a transmission of heat through the both sides of the slot 114. The slot 114 suppresses a transmission of heat from the wire connection portion 112 to the wiring conductor 106 around the wire connection portion 112. As a result, a time until the solder reaches a temperature at which the solder is melted when the wire connection portion 112 is caused to contact with a soldering iron becomes short, and thus the lead wire 52A and the wiring conductor 106 can be prevented from being deteriorated.

The wiring member 104 has a corresponding portion to the slot 114 which has only the base film 108 and the cover film 110, and thus a recess (unillustrated) may be formed in the thickness direction. When such a recess becomes in communication with an external space of the wiring member 104, a leak passage for particles may be formed. In order to address this disadvantage, according to this embodiment, the slot 114 is provided in such a manner as to be surrounded by the wiring conductor 106 and be isolated from the external area of the wiring member 104. Since the wiring conductor 106 is present between the slot 114 and the external edge of the wiring member 104, the possibility that the recess in the thickness direction corresponding to the slot 114 becomes in communication with the external space of the wiring member 104 is remarkably reduced.

When the wire connection portion 112 has a small area, the work efficiency of soldering the lead wire 52A to the wire connection portion 112 becomes poor. In order to address this disadvantage, the slot 114 may be provided between the thickness decreasing portion 120 and the base opening 54A (indicated by a dashed line in FIG. 4) in the planar direction. Even if the base opening 54A is small, the area of the wire connection portion 112 can be increased, and thus the reduction of the work efficiency can be prevented. According to this embodiment illustrated in FIG. 4, the slot 114 is provided so as to partially overlap the edge of the base opening 54A in the planar direction. In this case, also, even if the recess in the thickness direction corresponding to the slot 114 becomes in communication with the base opening 54A, the wiring conductor 106 is present between the slot 114 and the external edge of the wiring member 104 as explained above, and thus the space formed by the base opening 54A and the recess corresponding to the slot 114 is surrounded by the portion of the wiring member 104 corresponding to the area where the wiring conductor 106 is present between the base film 108 and the cover film 110. Hence, the possibility that the base opening 54A becomes in communication with the external space is remarkably reduced.

A plurality of slots 114 may be provided for one wire connection portion 112. In the embodiment illustrated in FIG. 4, the four slots 114 are provided for one wire connection portion 112. Moreover, the slots 114 are provided in such a way that the wire connection portion 112 is present therebetween in the planar direction. An advantage of suppressing a thermal conduction becomes further improved in comparison with a case in which the slot 114 is provided at only one side of the wire connection portion 112. The slot 114 is formed in a substantially arc shape in this embodiment. The slot 114 can be elongated to improve the advantage of suppressing a thermal conduction in comparison with a case in which the slot 114 is linear. Moreover, as illustrated in FIG. 4, the slots 114 may be provided in the planar direction in such a way that the slot 114 divided into plural slots 114 surround one wire connection portion 112. A conductor present between the slot 114 and the adjacent slot 114 allows the wire connection portion 112 to be electrically connected with the wiring conductor 106 at the outer circumferences of the slots 114. It is advantageous since the wire connection portion 112 is not likely to be peeled from the base film 108. Moreover, as illustrated in FIG. 5, the slot 114 may be provided in such a way that the one slot 114 surrounds one wire connection portion 112 in the planar direction. The advantage of suppressing a thermal conduction is further improved.

In the embodiment illustrated in FIGS. 4 and 5, the opening 110A of the cover film 110 partially overlaps the slot 114 in the planar direction. This air-tightly encloses air inside the slot 114, thereby suppressing an expansion or a shrinkage due to a pressure difference from the external space. Moreover, in the embodiment illustrated in FIG. 6, the slot 114 at least partially overlaps the base opening 54A in the planar direction. It is advantageous since the area of the wire connection portion 112 can be reduced even if the base opening 54A is large.

When the slot 114 has a width dimension in the planar direction that is too narrow, the advantage of suppressing a thermal conduction is deteriorated and the workability may become poor. Moreover, when the slot 114 has the width dimension in the planar direction that is too wide, the recess at a portion corresponding to the slot 114 has a deep depth dimension, and a leak passage may be formed in the planar direction. In this embodiment, the wiring conductor 106 has a thickness dimension that is within a range from 0.01 to 0.05 mm, and the slot 114 has the minimum width dimension that is within a range from 0.3 to 0.7 mm in the planar direction. It is confirmed that this structure brings about no technical disadvantage in the workability, and a sufficient leak formation suppressing advantage can be obtained.

The structures of the lead wires 52B and 52C are the same as that of the lead wire 52A, and thus the duplicated explanation will be omitted. The above-explained structure can reduce the possibility of causing a leakage from the base opening, and thus the reliability of the airtightness is improved. As a result, the upper-face-4A side of the base 4 can be maintained in a clean condition having little particles.

The present invention was explained based on the embodiment, but the above-explained embodiment is for exemplification, and indicates merely the principle and application of the present invention. It should be understood for those skilled in the art that the embodiment can be changed and modified in various forms and can permit a change in the disposition and the layout without departing from the scope and spirit of the present invention set forth in appended claims, and such a change and a modification are within the scope and spirit of the present invention.

In the above-explained embodiment, the explanation was given of the example case in which the through-hole of the wiring member is provided at a location overlapping the base opening in the planar direction, but the present invention is not limited to this case. The same advantages can be accomplished when the through-hole of the wiring member is provided at a location avoiding an overlap with the base opening. In the above-explained embodiment, the explanation was given of the example case in which the wire connection portion is provided around the through-hole of the wiring member, but the present invention is not limited to this case. The same advantages can be accomplished when the wire connection portion is provided so as to avoid overlapping the through-hole.

Although the explanation was given of the example case in which the wiring member includes the base film, the cover film and the wiring conductor all in a general specification in the above-explained embodiment, the present invention is not limited to this case. The same advantages can be accomplished when the base film, the cover film, and the wiring conductor in a particular specification are used.

Although the explanation was given of the example case in which the three lead wires of the brushless motor are caused to pass through respective base openings so that each wire passes through each base opening in the above-explained embodiment, the present invention is not limited to this case. The same advantages can be accomplished when a plurality of wires are caused to pass through one base opening. It should be understood for those skilled in the art that the number of lead wires of the brushless motor is not limited to three.

Although the explanation was given of the example case in which no filler is placed in the base opening in the above-explained embodiment, the present invention is not limited to this case. For example, a bond may be filled in the base opening. A bond may be applied so as to cover the lead wire connected to the wire connection portion. The explanation was given of the example case in which the wiring member is firmly attached to the base by a double-sided tape in the above-explained embodiment, but the present invention is not limited to this case. For example, a technique of firmly attaching the wiring member using a bond, or a combination of a plurality of attaching techniques may be applied. Moreover, a recess that can retain the wiring member may be formed in the lower face of the base, the wiring member may be firmly attached to that recess, and a seal may be firmly applied across the edge of the wiring member and the circumference of the recess. This further suppresses a leakage from the base opening.

The explanation was given of the example case in which the present invention is applied to the lead wire of the motor in the above-explained embodiment, but the present invention is not limited to this case. For example, the present invention can be applied to the lead wire of the voice coil motor. The same advantages can be accomplished in this case. In the above-explained embodiment, the explanation was given of the example case in which the lead wire of the motor is connected to the wire connection portion by soldering, but the present invention is not limited to this case. For example, the lead wire of the motor may be connected to the wire connection portion by other techniques, such as brazing and welding.

In the above-explained embodiment, although the explanation was given of the example case in which the sleeve is fixed to the base and the shaft rotates relative to the sleeve, the present invention is not limited to this case. For example, the present invention is applicable to a fixed-shaft type rotating device which has a shaft fixed to the base, and which also has a sleeve rotating together with a hub relative to the shaft.

What is claimed is:

1. A disk drive device comprising:
a base formed with a base opening that passes all a way through a first face and a second face opposite to the first face;
a rotating body which is provided in the base at the first face side and to which a recording disk is to be mounted;
a wiring member which includes a first film, a second film, and a wiring conductor present between the first film and the second film, and which is provided on the second face of the base to cover the base opening;
a lead wire which passes through the base opening and which is fixed to a wire connection portion of the wiring conductor;
a thickness decreasing portion which is a part of the wiring member, decreases a thickness in accordance with an edge of the wiring conductor, and is located outwardly of the base opening in a planar direction; and
a slot which is a part of the wiring member, is an area having no conductor and having an entire circumference surrounded by the wiring conductor between the first film and the second film in the planar direction, and is present between the wire connection portion and the thickness decreasing portion.

2. The disk drive device according to claim 1, further comprising a motor which is configured to rotate the rotating body, is provided in the base at the first face side, and is connected to the lead wire.

3. The disk drive device according to claim 1, wherein
the slot is a plurality of slots, and
the wire connection portion is disposed between the plurality of slots in the planar direction.

4. The disk drive device according to claim 1, wherein the slot surrounds the wire connection portion in the planar direction.

5. The disk drive device according to claim 1, wherein the slot is present between the thickness decreasing portion and an edge of the base opening in the planar direction.

6. The disk drive device according to claim 1, wherein the slot at least partially overlaps the base opening in the planar direction.

7. The disk drive device according to claim 1, wherein
the wiring member is further formed with a film opening which is formed at a location overlapping the base opening in the planar direction and which passes all a way through the wiring member, and
the lead wire passes through the base opening and the film opening, and is fixed to the wire connection portion by soldering.

8. The disk drive device according to claim 1, further comprising a double-sided tape present between the wiring member and the base.

9. The disk drive device according to claim 1, wherein
a thickness dimension of the wiring conductor is within a range from 0.01 to 0.05 mm, and
a minimum width dimension of the slot in the planar direction is within a range from 0.3 to 0.7 mm.

10. A disk drive device comprising:
a base which comprises a first face and a second face opposite to the first face, and which is formed with a base opening passing all a way through the first face and a second face;
a motor which comprises a coil and which is retained in the base at the first face side; and
a wiring member which comprises a first film, a second film and a wiring conductor present between the first film and the second film and electrically coupled with the coil of the motor, and which is disposed on the second face in such a way that a portion of the wiring member corresponding to an area where the wring conductor is present between the first film and the second film surrounds an outer edge of the base opening.

11. The disk drive device according to claim 10, wherein
the coil of the motor comprises a wire which passes through the base opening and which extends from the base opening,
the wiring member is disposed in such a way that the first film contacts the second face of the base,
the wiring conductor comprises a wire connection portion electrically coupled with the wire, and
the first film is formed with an opening that allows the wire to lead the wire connection portion.

12. The disk drive device according to claim 11, wherein the wiring conductor further comprises a slot that is an area which is provided at an arbitrary location around an outer circumference of the wire connection portion in a planar direction, has an entire circumference surrounded by the wiring conductor and has no conductor.

13. The disk drive device according to claim 12, wherein the slot is disposed at a location partially overlapping the base opening.

14. The disk drive device according to claim 12, wherein the slot is a plurality of slots, and the plurality of slots are provided at respective arbitrary locations around the outer circumference of the wire connection portion.

15. The disk drive device according to claim 12, wherein the slot is formed in a substantially arc shape.

16. The disk drive device according to claim 12, wherein
a thickness dimension of the wiring conductor is within a range from 0.01 to 0.05 mm, and
a minimum width dimension of the slot in the planar direction is within a range from 0.3 to 0.7 mm.

17. The disk drive device according to claim 11, wherein the opening of the first film is formed at a location corresponding to the wire connection portion.

18. The disk drive device according to claim 10, wherein the base opening is filled with a filler.

19. The disk drive device according to claim 10, wherein
the first and second films are each formed of a film having a thickness of to 50 μm, and
the wiring conductor is formed of a copper foil having a thickness of 12 to 50 μm.

20. A disk drive device comprising:
a motor configured to rotate and drive a disk;
a wire extending from the motor;
a base which comprises a first face and a second face, retains the motor at the first face side, and is formed with a base opening that allows the wire to pass through from the first face side to the second face side;
a wiring member that comprises a first film, a second film, and a wiring conductor disposed between the first film and the second film and electrically coupled with the wire, a portion of the wiring member corresponding to an area where no wiring conductor is present between the first film and the second film being disposed outwardly of the base opening in a planar direction; and
a slot which is a pore provided in the wiring conductor and having an entire circumference surrounded by the wiring conductor, and which is provided around a portion where the wiring member is coupled with the wire.
